(19) United States
(12) Patent Application Publication
(10) Pub. No.: US 2022/0010832 A1
(43) Pub. Date: Jan. 13, 2022

(54) MECHANICALLY FASTENED JOINT WITH IN-SITU THERMALLY CURED SEAL

(71) Applicant: Ford Global Technologies, LLC, Dearborn, MI (US)

(72) Inventors: Amanda Kay Freis, Ann Arbor, MI (US); Garret Sankey Huff, Ann Arbor, MI (US)

(73) Assignee: Ford Global Technologies, LLC, Dearborn, MI (US)

(21) Appl. No.: 16/924,754

(22) Filed: Jul. 9, 2020

(51) Int. Cl. F16B 43/00; F16J 15/06; F16B 35/06

(52) U.S. Cl. CPC F16B 43/001; F16B 35/06; F16J 15/062

(57) ABSTRACT

A method of installing and sealing a friction fastener to at least an upper substrate and a lower substrate includes providing an expandable sealant to an underhead volume of the friction fastener, installing the friction fastener through the upper substrate and into the lower substrate using a joining device, and applying heat in-situ to the expandable sealant such that the friction fastener is sealed to at least the upper substrate. The heat in-situ is applied to the expandable sealant via installing the friction fastener and/or with an external heating source disposed downstream from the joining device.

### FIELD

The present disclosure relates generally to mechanical fastening, and more particularly, to corrosion protection for use in joining adjacent workpieces.

### BACKGROUND

The statements in this section merely provide background information related to the present disclosure and may not constitute prior art.

Joining of thin metal substrates layers (e.g., less than 5 mm thick) to form structural assemblies is typically performed using techniques such as resistance spot welding, self-piercing riveting, friction element welding, and friction flow screwing, among others. And when mechanical fastening techniques are used, such as friction flow screwing, sealants can be employed at joints between the mechanical fasteners and the metal substrate layers such that water and/or debris does not enter or migrate into the joints between the metallic sheet materials. For example, water and/or debris may enter or migrate into a joint or interface between a friction fastener and one or more metal substrate layers when a proper seal between the friction fastener and the metal substrate layer(s) is not provided, thereby resulting in corrosion at the joint or interface.

These issues related to corrosion at interfaces between mechanical fasteners and metal substrates, and other issues related to joining of substrates using mechanical fasteners, are addressed by the present disclosure.

### SUMMARY

In one form of the present disclosure, a method of installing and sealing a friction fastener to at least an upper substrate and a lower substrate includes providing an expandable sealant to an underhead volume of the friction fastener, installing the friction fastener through the upper substrate and into the lower substrate using a joining device, and applying heat in-situ to the expandable sealant such that the friction fastener is sealed to at least the upper substrate.

In one form, the heat in-situ is applied to the expandable sealant via installing the friction fastener. In this form, installing the friction fastener generates temperatures sufficient to reach an onset temperature of the expandable sealant. In other variations, the heat in-situ is applied to the expandable sealant with an external heating source disposed downstream from the joining device. In at least one form, the external heating source is disposed upstream from a bath. For example, in some variations, the heat in-situ is applied to the expandable sealant before entering a painting process and/or before entering an E-coat bath(s) and oven(s). Also, in at least one variation, the expandable sealant is a synthetic elastomer.

In some variations, the method includes a controller configured to activate the external heating source for a predetermined time up to a predetermined temperature as a function of joint characteristics. In such variations, the joint characteristics include number of substrate layers, type of substrate layer, substrate layer material, substrate layer thickness, friction fastener geometry, friction fastener material, friction fastener drive type, clearance holes, joint thinning, pilot holes, sealing material, and sealing material thickness, among others.

In another form of the present disclosure, a method of installing and sealing a friction fastener to at least an upper substrate and a lower substrate includes providing an expandable sealant to an interface between the friction fastener and the upper substrate, installing the friction fastener through the upper substrate and into the lower substrate using a joining device, and applying heat in-situ to the expandable sealant by the friction fastener. In some variations, the method includes applying additional heat in-situ with an external heating source downstream from the joining device. In at least one variation, the interface where the expandable sealant is provided is at least one of an underhead volume of the friction fastener and a sidewall of a clearance hole in the upper substrate. Also, in some variations, the external heating source applies heat after installation of the friction fastener and before the friction fastener enters a bath.

In still another form, a structural assembly includes at least an upper substrate, a lower substrate, and a friction fastener extending through the upper substrate and into the lower substrate. The friction fastener has a head portion defining an underhead volume, and an expanded sealant disposed within the underhead volume and extending along at least a portion of a threaded shank of the friction fastener. The structural assembly is formed by providing an expandable sealant to the underhead volume of the friction fastener, installing the friction fastener through the upper substrate and into the lower substrate using a joining device, and applying heat in-situ to the expandable sealant by the friction fastener.

In some variations, an external heating source is disposed downstream from the joining device and the external heating source applies additional heat in-situ to the expandable sealant.

In at least one form, the upper substrate is a different material from a material of the lower substrate. For example, the upper substrate is a steel alloy, and the lower substrate is an aluminum alloy.

In some variations, at least one of the friction fastener and the upper substrate includes a radial distribution feature configured to promote radial expansion of the expandable sealant. Also, in at least one variation, the structural assembly includes an additional substrate layer disposed between the upper substrate and the lower substrate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is side view of a friction fastener according to the teachings of the present disclosure;

FIGS. 2A-2F are a series of steps for joining metal substrate layers together using the friction fastener in FIG. 1 where: FIG. 2A shows aligning the friction fastener with a clearance hole in an upper substrate; FIG. 2B-2C show self-piercing of a lower substrate with the friction fastener; FIG. 2D shows thread forming in the lower substrate with the friction fastener; FIG. 2E shows screwing of the friction fastener into the lower substrate; and FIG. 2F shows the upper substrate and the lower substrate joined together after a desired torque has been applied to the friction fastener;

FIG. 3 is an enlarged and partial cross-sectional view of FIG. 2F;

FIG. 4A is a photograph of a cross-section of metal substrate layers joined together with a friction fastener before the expandable sealant has been heated to its onset temperature according to the teachings of the present disclosure;

FIG. 4B is a photograph of a cross-section of metal substrate layers joined together with a friction fastener after the expandable sealant has been heated to its onset temperature according to the teachings of the present disclosure;

FIG. 5 is another photograph of a cross-section of metal substrate layers joined together with a friction fastener according to the teachings of the present disclosure;

FIG. 6 is flow chart for methods of installing and sealing a friction fastener to an upper substrate and a lower substrate according to the teachings of the present disclosure;

FIG. 7A-7C is a series of steps for installing and sealing a friction fastener to an upper substrate and a lower substrate according to a method in FIG. 6;

FIG. 8A-8D is another series of steps for installing and sealing a friction fastener to an upper substrate and a lower substrate according to another method in FIG. 6;

FIG. 9A-9C is a still another series of steps for installing and sealing a friction fastener to an upper substrate and a lower substrate according to still another method in FIG. 6;

FIG. 10 is a photograph of a joining device with an external heating source according to the teachings of the present disclosure;

FIG. 11 is a photograph of a cross-section of three metal substrate layers joined together with a friction fastener according to the teachings of the present disclosure;

FIG. 12 is another photograph of a cross-section of three metal substrate layers joined together with a friction fastener according to the teachings of the present disclosure;

FIG. 13 is a photograph of a cross-section of four metal substrate layers joined together with a friction fastener according to the teachings of the present disclosure; and

FIG. 14 is another photograph of a cross-section of four metal substrate layers joined together with a friction fastener according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

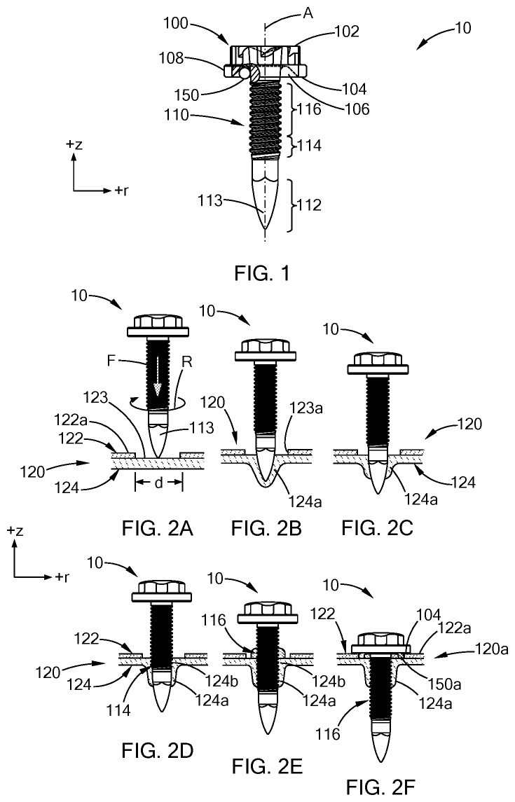

Referring to FIG. 1, a friction fastener 10 according to the teachings of the present disclosure includes a head portion 100 and a threaded shank 110 extending along a central axis ‘A’. The head portion 100 includes an upper (+z direction) surface 102, a lower (−z direction) surface 104, a radial outward (+r direction) surface 108, and an underhead volume 106 positioned or located below (−z direction) the upper surface 104 of the head portion 100. An expandable sealant 150 is positioned or located at least partially within the underhead volume 106. As used herein, the phrase “underhead volume” refers to a volume of space configured for the placement or containing of the expandable sealant 150 and positioned between the upper surface 102 of the head portion 100 and a metal substrate to be joined to another metal substrate using the friction fastener 10. In some variations of the present disclosure, the underhead volume 106 is defined between the upper surface 102 and the lower surface 104 as shown in FIG. 1. In such variations, the underhead volume 106 can also be defined or be located radially inward from the radial outward surface 108.

The friction fastener 10 is made from a metallic material. Non-limiting examples of such metallic materials include steels, stainless steels, nickel alloys, titanium alloys, aluminum alloys, among others.

In some variations, the expandable sealant 150 is provided at an interface (not labeled) between the friction fastener 10 and an upper substrate 122 (FIG. 2A). In such variations, the interface can include at least one of the underhead volume 106 and a sidewall 123A (FIG. 2B) of a clearance hole 123 (FIG. 2A) in the upper substrate 122. Also, in some variations, the expandable sealant 150 is provided to the interface by direct extrusion from a container (not shown) and the expandable sealant 150 adheres to the interface such that the friction fastener 10 with the expandable sealant 150 is handled and installed through an upper substrate and into a lower substrate using a joining device as described below.

Non-limiting examples of the expandable sealant 150 include rubber-based elastomers and synthetic elastomers such as ethylene-vinyl acetate (EVA) based elastomers that exhibit large expansion (e.g., >1000% volume expansion) when heated to temperatures above an onset temperature for the material for a given amount of time. For example, the expandable sealant is heated to an offset temperature between 212° F. and 752° F. for a time between 1 second and 600 seconds. In some variations, the expandable sealant 150 exhibits over 1000% volume expansion when heated to an onset temperature of 275° F. for 30 minutes and/or an onset temperature of 300° F. for 2 minutes. In at least one variation, the expandable sealant 150 exhibits over 1500% volume expansion when heated to onset temperature of 275° F. for 50 minutes and/or onset temperature of 300° F. for 10 minutes. And in some variations, the expandable sealant 150 exhibits over and over 2000% volume expansion when heated to onset temperature of 300° F. for 20 minutes and/or onset temperature of 325° F. for 2 minutes. The expandable sealant 150, after expansion, has a closed cell structure and in combination with the large expansion range is configured to seal cavities and interfaces between components as described below.

The threaded shank 110 includes a tip portion 112 with a tip 113, a thread forming portion 114, and a threaded portion 116. While the threaded shank 110 is shown as cylindrical in FIG. 1, i.e., the threaded shank 110 has a circular cross-section, it should be understood that in some variations the threaded shank 110 or any portion of the threaded shank 110 (e.g., the tip portion 112 has a triangular cross-section, pentagon cross-section, or a hexagonal cross-section, among others.

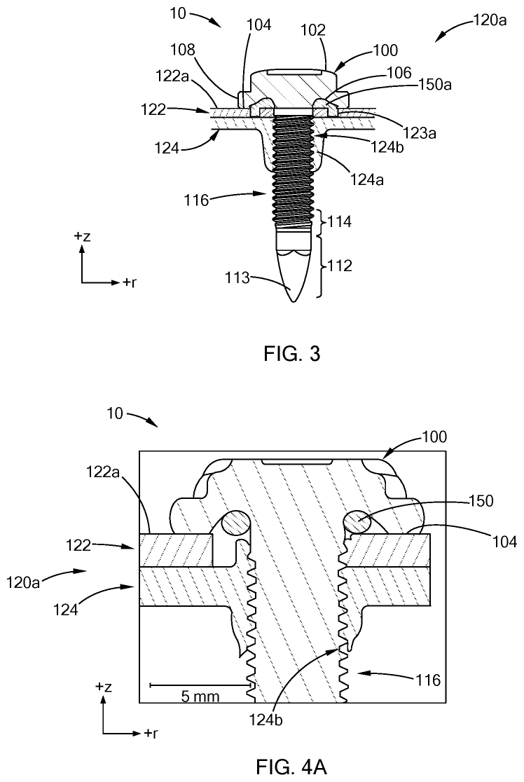

Referring to FIGS. 2A-2F, a series of steps that occur during joining an upper sheet metal substrate 122 (also referred to herein as “upper substrate”) to a lower substrate 124 of a structural assembly 120 with the friction fastener 10 is shown. Particularly, the friction fastener 10 is aligned with a clearance hole 123 with an inner dimension ‘d’ (e.g., an inner diameter ‘d’) in FIG. 2A and the tip 113 is brought into contact with the lower substrate 124 while force ‘F’ and rotation ‘R’ are applied to the friction fastener 10. The force F and rotation R of the friction fastener 10 generate heat and plastic deformation in the lower substrate 124 such that a deformed region 124a is formed as the tip 113 advances (−z direction) into the lower substrate 124 as shown in FIG. 2B. The tip 113 penetrates through the deformed region 124a of the lower substrate 124 as shown in FIG. 2C and the friction fastener 10 advances (−z direction) through the lower substrate 124 and the thread forming portion 114 forms threads 124b (FIG. 3) within the deformed region 124a as shown in FIG. 2D. The threaded portion 116 of the threaded shank 110 engages the threads 124b in the deformed region 124a such that the friction fastener 10 continues advancing through the lower substrate 124 as shown in FIG. 2E until the lower surface 104 of the head portion 100 comes into contact with an upper surface 122a of the upper substrate 122 as shown in FIG. 2F. Also, a desired amount of torque is applied to the friction fastener 10, and during and/or after the desired amount of torque is applied to the friction fastener 10, heat in-situ is applied to the expandable sealant 150. The heat in-situ results in expansion of the expandable sealant 150 (i.e., expanded sealant 150a is formed) such that a water-tight seal is formed between the head portion 100 and the upper surface 122a of the upper substrate 122 and a joined structural assembly 120a is provided.

As used herein, the phrase “heat in-situ” refers to heat applied to the expandable sealant 150 during and/or after (e.g., downstream) installation of the friction fastener 10 but before the joined structural assembly 120a enters a painting process and/or is placed in a bath, e.g., an E-coat bath(s) and/or oven(s). In some variations, the heat in-situ is applied to the expandable sealant 150 within a time frame equal to or less than 1 hour, e.g., equal to or less than 30 minutes, equal to or less than 15 minutes, equal to or less than 10 minutes, equal to or less than 5 minutes, equal to or less than 1 minute, or equal to or less than 30 seconds. In the alternative, or in addition too, in some variations the heat in-situ is applied to the expandable sealant 150 within a predefined distance from an assembly station where the friction fastener 10 is installed. For example, the heat in-situ is applied to the expandable sealant 150 within a distance equal to or less than 5 meters, a distance equal to or less than 2.5 meters, a distance equal to or less than 1 meter, or a distance equal to or less than 0.5 meters from an assembly station where the friction fastener 10 is installed.

Referring to FIG. 3, an enlarged view of FIG. 2F with a cross-section of the head portion 100 is shown. Particularly, the joined structural assembly 120a includes the upper substrate 122 joined to the lower substrate 124. The deformed region 124a of the lower substrate 124 extends downward (−z direction along the threaded shank 110 of the friction fastener 10 and upward (+z direction) into the clearance hole 123 in the upper substrate 122. The expanded sealant 150a fills the underhead volume 106 and the space between the threaded shank 110 and the sidewall 123a of the clearance hole 123. That is, the expanded sealant 150a keeps or prevents water, debris, and other contaminants, from entering or migrating between the lower surface 104 of the head portion 100 and the upper surface 122a of the lower substrate 122. Accordingly, corrosion is inhibited at the joint formed by the friction fastener 10 between the upper substrate 122 and the lower substrate 124.

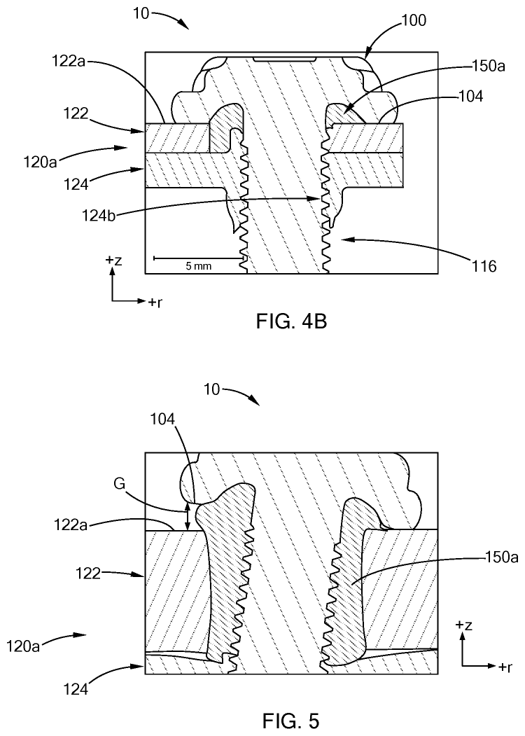

Referring to FIGS. 4A and 4B, photographs of a cross-sections of the friction fastener 10 installed through the upper substrate 122 and into the lower substrate 124 are shown. FIG. 4A illustrates the joint before the expandable sealant 150 (shown with a grid pattern for clarity) has been heated to its onset temperature, and FIG. 4B shows the friction fastener 10 installed through the upper substrate 122 and into the lower substrate 124 after the expandable sealant 150 has been heated to its onset temperature. In the example shown in FIGS. 4A and 4B, the upper substrate 122 and the lower substrate 124 are formed from aluminum alloys, the friction fastener 10 is formed from steel, and the expandable sealant 150 is a synthetic elastomer. However, it should be understood that different materials may be used for the substrates 122/124 and friction fastener 10 while remaining within the scope of the present disclosure.

While the example shown in FIG. 4 shows the friction fastener desirably aligned with the upper and lower substrates 122, 124 such that the lower surface 104 of the head portion 100 is in contact with the upper surface 122a of the upper substrate 122, it should be understood that the teachings of the present disclosure provide for desired sealing of the joint formed by the friction fastener 10 between the upper substrate 122 and the lower substrate 124 when the friction fastener is not desirably aligned with the upper and lower substrates 122, 124 as shown in FIG. 5. Particularly, FIG. 5 shows a photograph of another cross-section of joined structural assembly 120a where a gap ‘G’ is present between at least a portion of the lower surface 104 (i.e., the lower surface 104 on the left hand side of the figure) and the upper surface 122a of the upper substrate 122. However, the expandable sealant 150 has expanded such that the gap G is filled with the expanded sealant 150a and corrosion is inhibited at the joint formed by the friction fastener 10 between the upper substrate 122 and the lower substrate 124 shown in the figure.

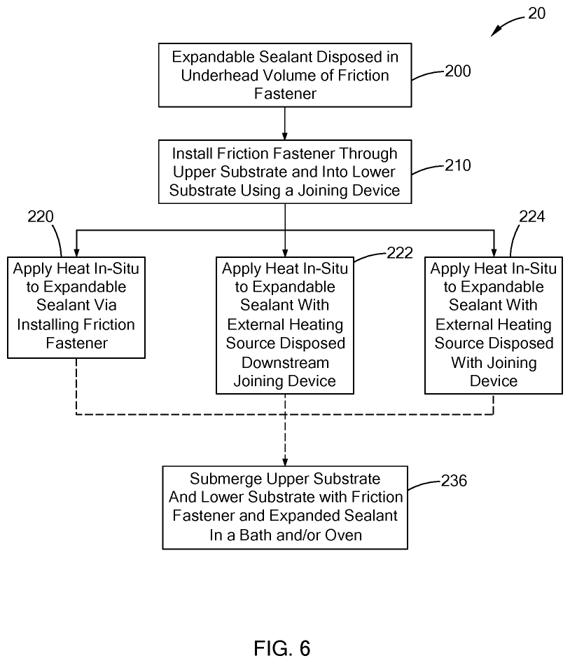

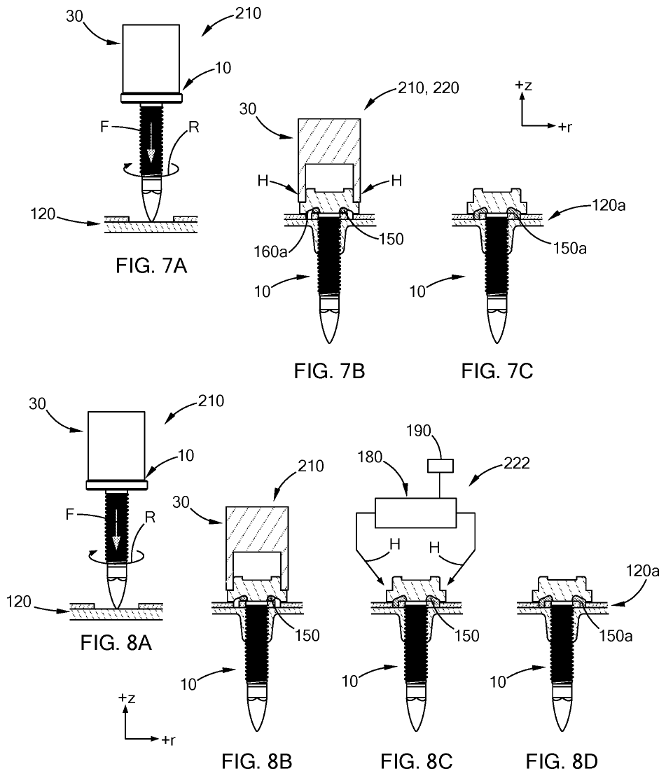

Referring to FIG. 6, a flow chart for at least one method 20 for installing and sealing a friction fastener to at least an upper substrate and a lower substrate is shown. For example, and with reference to FIGS. 6 and 7A-7C, the method 20 includes providing an expandable sealant 150 to an underhead volume 106 of a friction fastener 10 at 200 and installing the friction fastener 10 through an upper substrate 122 and into a lower substrate 124 using a joining device 30 at 210 (FIGS. 7A-7B). In some variations of the present disclosure, at least one of the friction fastener 10 and the upper substrate 122 includes a radial distribution feature 106a (FIG. 7B) configured to promote radial expansion of the expandable sealant 150. Heat in-situ ‘H’ is applied to the expandable sealant 150 during installation of the friction fastener 10 at 220 (FIG. 7B) such that the expandable sealant 150 expands and forms the expanded sealant 150a (FIG. 7C). It should be understood that the heat in-situ at 220 is heated generated by friction between the friction fastener 10 and the lower substrate 122 and the heat in-situ H generates temperatures sufficient to reach an onset temperature of the expandable sealant 150. In some variations of the present disclosure, the joint formed by the upper substrate 122, the lower substrate 124, the friction fastener 10, the expanded sealant 150a are submerged into a bath and/or an oven at 226.

In another example, and with reference to FIGS. 6 and 8A-8D, the method 20 includes providing an expandable sealant 150 to an underhead volume 106 of a friction fastener 10 at 200 and installing the friction fastener 10 through an upper substrate 122 and into a lower substrate 124 using the joining device 30 at 210 (FIGS. 8A-8B). Heat in-situ ‘H’ is applied to the expandable sealant 150 with an external heating source 180 disposed downstream from the joining device 30 (FIG. 8C) such that the expandable sealant 150 expands and forms the expanded sealant 150a (FIG. 8D). In some variations, heat in-situ H is applied at 210 (FIG. 8B, i.e., during installing the friction fastener 10) and additional heat in-situ H is applied at 222 with the external heating source 180 (FIG. 8C). In some variations of the present disclosure, the joint formed by the upper substrate 122, the lower substrate 124, the friction fastener 10, the expanded sealant 150a are submerged into a bath and/or an oven at 226.

In at least one variation, a controller 190 is included and in communication with the external heating source 180. The controller 190 is controller configured to activate the external heating source 180 for a predetermined time up to a predetermined temperature (e.g., an onset temperature) as a function of characteristics of the joint (also referred to herein as “joint characteristics”) formed between the friction fastener 10, the upper substrate 122, and the lower substrate 124. Non-limiting examples of joint characteristics include number of substrate layers, type of substrate layer, substrate layer material, substrate layer thickness, friction fastener geometry, friction fastener material, friction fastener drive type, clearance holes, joint thinning, pilot holes, sealing materials, and sealing material thickness, among others. Also, it should be understood that the heat in-situ H at 222 applied by the external heating source 180 disposed downstream from the joining device generates temperatures sufficient to reach an onset temperature of the expandable sealant 150.

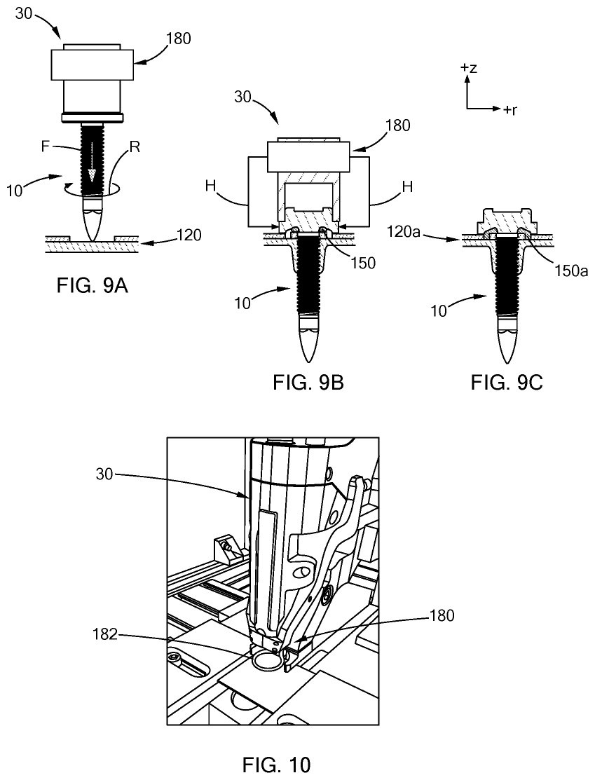

In still another example, and with reference to FIGS. 6 and 9A-9C, the method 20 includes providing an expandable sealant 150 to an underhead volume 106 of a friction fastener 10 at 200 and installing the friction fastener 10 through an upper substrate 122 and into a lower substrate 124 using the joining device 30 at 210 (FIGS. 9A-9B). Heat in-situ ‘H’ is applied to the expandable sealant 150 with an external heating source 180 disposed with the joining device 30 (FIG. 9B) such that the expandable sealant 150 expands and forms the expanded sealant 150a (FIG. 9C). It should be understood that the heat in-situ H at 222 applied by the external heating source 180 disposed with the joining device 30 generates temperatures sufficient to reach an onset temperature of the expandable sealant 150. In some variations of the present disclosure, the joint formed by the upper substrate 122, the lower substrate 124, the friction fastener 10, the expanded sealant 150a are submerged into a bath and/or an oven at 226.

Referring to FIG. 10 one example of an external heating source 180 disposed with a joining device 30 is shown. In some variations, the external heating source is an induction heating source 180 with an induction coil 182. In such variations, the induction coil 182 is energized and applies heat in-situ to the expandable sealant 150 during and/or after the installation of the friction fastener 10 (FIG. 9B).

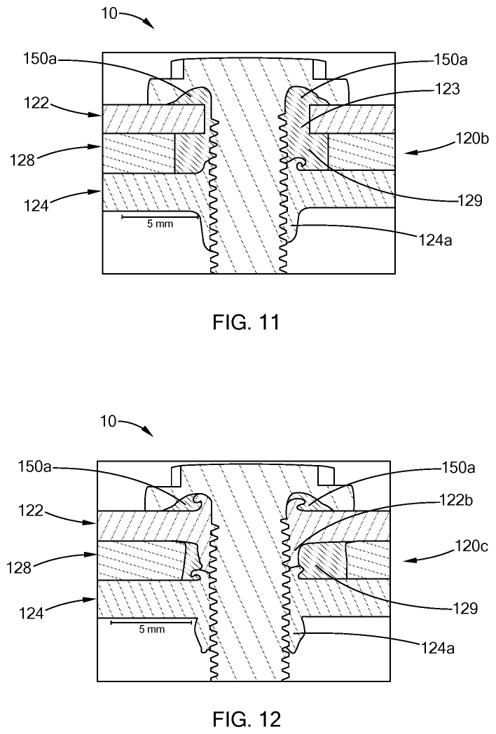

While the figures described above show the structural assembly 120 and the joined structural assembly 120a with only an upper substrate 122 and a lower substrate 124 (i.e., two layers), the teachings of the present disclosure include structural assembles and joined structural assemblies with one or more additional substrate layers disposed between the upper substrate 122 and the lower substrate 124. For example, FIG. 11 shows a joined structural assembly 120b with an additional substrate 128 disposed between an upper substrate 122 and a lower substrate 124. The upper substrate 122 has the clearance hole 123 and the intermediate substrate 128 has a clearance hole 129. Also, FIG. 12 shows another joined structural assembly 120c with the additional substrate 128 disposed between the upper substrate 122 and the lower substrate 124 according to the teachings of the present disclosure. The intermediate substrate 128 has a clearance hole 129 but the upper substrate 122 does not have the clearance hole 123. Accordingly, during installation of the friction fastener 10, the tip 113 pierces the upper substrate 122 and the lower substrate 124 such that a deformed region 122b with threads (not labeled) and a deformed region 124a with threads (not labeled) are formed.

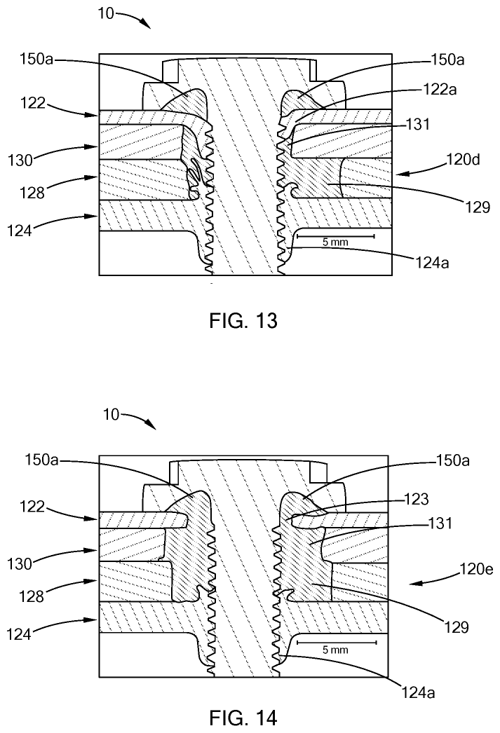

Referring to FIG. 13, a joined structural assembly 120d is shown with four substrate layers. Particularly, the joined structural assembly 120d has a first intermediate substrate 128 and a second intermediate substrate 130 between the upper substrate 122 and the lower substrate 124. The first intermediate substrate 128 has a clearance hole 129 and the second intermediate substrate 130 has a clearance hole 131. However, the upper substrate 122 does not have the clearance hole 123. Accordingly, during installation of the friction fastener 10, the tip 113 pierces the upper substrate 122 and the lower substrate 124 such that a deformed region 122a with threads (not labeled) and a deformed region 124a with threads (not labeled) are formed.

Referring to FIG. 14, another joined structural assembly 120e with four substrate layers is shown. Particularly, the joined structural assembly 120e has the first intermediate substrate 128 and the second intermediate substrate 130 between the upper substrate 122 and the lower substrate 124. The first intermediate substrate 128 has a clearance hole 129, the second intermediate substrate 130 has a clearance hole 131, and the upper substrate has the clearance hole 123. Accordingly, during installation of the friction fastener 10, the tip 113 only pierces the lower substrate 124 such that a deformed region 124a with threads (not labeled) is formed.

It should be understood from the teachings of the present disclosure that a method for forming a mechanically fastened joint with in-situ thermally cured sealant and a structural assembly formed by the method are provided. The method provides for mechanically fastening substrate layers together and sealing joints and/or interfaces between mechanical fasteners and the substrate layers by applying heat in-situ to an expandable sealant disposed at the joints and/or interfaces. Applying heat in-situ to the expandable sealant disposed at the joints and/or interfaces results in large expansion and curing of the expandable sealant before entering a painting process (e.g., an E-Coat bath) and/or an oven. That is, an oven is not required for curing of the expandable sealant.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of installing and sealing a friction fastener to at least an upper substrate and a lower substrate, the method comprising:
providing an expandable sealant to an underhead volume of the friction fastener;
installing the friction fastener through the upper substrate and into the lower substrate using a joining device; and
applying heat in-situ to the expandable sealant such that the friction fastener is sealed to at least the upper substrate.

2. The method according to claim 1, wherein the heat in-situ is applied to the expandable sealant via installing the friction fastener.

3. The method according to claim 1, wherein installing the friction fastener generates temperatures sufficient to reach an onset temperature of the expandable sealant.

4. The method according to claim 1, wherein the heat in-situ is applied to the expandable sealant with an external heating source disposed downstream from the joining device.

5. The method according to claim 4, wherein the external heating source is disposed upstream from a bath.

6. The method according to claim 4 further comprising a controller configured to activate the external heating source for a predetermined time up to a predetermined temperature as a function of joint characteristics.

7. The method according to claim 6, wherein the joint characteristics are selected from the group consisting of number of layers, type of layer, layer material, layer thickness, friction fastener geometry, friction fastener material, friction fastener drive type, clearance holes, joint thinning, pilot holes, sealing materials, and sealing material thickness.

8. The method according to claim 1, wherein the heat in-situ is applied to the expandable sealant before entering a painting process.

9. The method according to claim 1, wherein the heat in-situ is applied to the expandable sealant before entering an E-coat bath.

10. The method according to claim 1, wherein the expandable sealant is a synthetic elastomer.

11. A method of installing and sealing a friction fastener to at least an upper substrate and a lower substrate, the method comprising:
providing an expandable sealant to an interface between the friction fastener and the upper substrate;
installing the friction fastener through the upper substrate and into the lower substrate using a joining device; and
applying heat in-situ to the expandable sealant by the friction fastener.

12. The method according to claim 11 further comprising applying additional heat in-situ with an external heating source downstream from the joining device.

13. The method according to claim 12, wherein the external heating source applies heat after installation of the friction fastener and before the friction fastener enters a bath.

14. The method according to claim 11, wherein the interface is at least one of an underhead volume of the friction fastener and a sidewall of a clearance hole in the upper substrate.

15. A structural assembly comprising at least an upper substrate, a lower substrate, a friction fastener extending through the upper substrate and into the lower substrate, the friction fastener having a head portion defining an underhead volume, and an expanded sealant disposed within the underhead volume and extending along at least a portion of a threaded shank of the friction fastener,
wherein the structural assembly is formed by:
providing an expandable sealant to the underhead volume of the friction fastener;
installing the friction fastener through the upper substrate and into the lower substrate using a joining device; and
applying heat in-situ to the expandable sealant by the friction fastener.

16. The structural assembly according to claim 15 further comprising an external heating source disposed downstream from the joining device, wherein the external heating source applies additional heat in-situ to the expandable sealant.

17. The structural assembly according to claim 15, wherein the upper substrate is a different material from a material of the lower substrate.

18. The structural assembly according to claim 15, wherein the upper substrate is a steel alloy, and the lower substrate is an aluminum alloy.

19. The structural assembly according to claim 15, wherein at least one of the friction fastener and the upper substrate includes a radial distribution feature configured to promote radial expansion of the expandable sealant.

20. The structural assembly according to claim 15 further comprising an additional substrate layer disposed between the upper substrate and the lower substrate.
